(19) United States
(12) Patent Application Publication
(10) Pub. No.: US 2010/0219632 A1
(43) Pub. Date: Sep. 2, 2010

(54) CONNECTING AND ATTACHMENT COMPONENT FOR A CORRUGATED HOSE

(75) Inventor: Dieter Fieber, Hainburg (DE)

Correspondence Address: ECKERT SEAMANS CHERIN & MELLOTT, LLC, U.S. STEEL TOWER, 600 GRANT STREET, PITTSBURGH, PA, 15219-2788, US

(73) Assignee: FLEXA GmbH & CO. PRODUKTION UND VERTRIEB KG, HANAU (DE)

(21) Appl. No.: 12/674,970

(22) PCT Filed: Aug. 4, 2008
(86) PCT No.: PCT/EP08/06401

§ 371 Date: Feb. 24, 2010

(30) Foreign Application Priority Data
Aug. 28, 2007 (DE) 10 2007 040 745.0

(51) Int. Cl. F16L 25/00

(52) U.S. Cl. 285/371

(57) ABSTRACT

A connecting and attachment component for a corrugated hose, having a sleeve-like basic body (1), with a corrugated-hose connecting end, and having an associated inner or outer sleeve (6), wherein the end of a corrugated hose can be plugged into the inner sleeve (6), which is inserted into the basic body (1), or, in conjunction with an outer sleeve, into the basic body (1), and the other end is designed in the form of a connecting element (3). At least two resilient arms (9) are provided on the sleeve (S) in each case, which at their base end (13) are secured on the sleeve (6) and, at their other, free end (10), have at least one radially running engagement protrusion (11) which extends inwards beyond the inner circumference of the sleeve (6) and can be brought into engagement with the corrugations of a corrugated hose, so as to arrest the latter.

The invention relates to a connection and attachment component for a corrugated hose, having a sleeve-like base body that exhibits a corrugated hose connection end, and having an associated inner and outer sleeve, whereby the end of a corrugated hose can be pushed into the inner sleeve, which is inserted into the base body, or is inserted into the base body in conjunction with an outer sleeve, and the other end of it is designed in the form of a connection element, and whereby at least two resilient arms are provided at the sleeve, with each such arm being secured at its base end to the sleeve and at its other free end exhibiting a radially progressing engagement protrusion, which extends inward beyond the inner circumference of the sleeve and can be brought into engagement with the corrugations of the corrugated hose such that it arrests the hose, whereby the base end points away from the corrugated hose connection end relative to the free end.

Such connection and attachment components are used to devise the end of a corrugated hose such that it can be connected to a pipe or a hose. Corrugated hoses are used to contain electric, pneumatic or other lines and thus to protect them; however, at the same time they are to exhibit sufficient flexibility to be adaptable to the circumstances during installation.

Connection and attachment components for corrugated hoses must clamp to the corrugated hose to ensure a secure hold and must be sufficiently solid and stable to be suitable even for rough application conditions.

Typically, such connection and attachment components are made of one base body. At its one end, this base body exhibits an attachment flange, for example in the form of a cylinder section, with a connecting hose or pipe being slipped onto the outside of said cylinder section and clamped to it using, for example, a pipe clamp. The other end exhibits an additional cylindrical section into which a corrugated hose that is to be connected is inserted. Furthermore, a ring is provided that is placed between the outside of the corrugated hose and the inner circumference of the attachment component. This adapter ring, or this adapter component, features inward protruding engagement catches that hook into the ring-shaped troughs of the corrugated hose. In addition, measures are provided that serve the purpose of holding the catch components in the troughs of the corrugation, even when tensile forces act upon the corrugated hose. Typically, the catch components are pressed into the troughs of the corrugation with a force that increases as such tensile forces increase.

A connection and attachment component for a corrugated hose of the aforementioned kind, also referred to as a “connection element”, is known from DE 40 20 171 C1. This connection element comprises a roughly cylindrical housing with an attachment component as well as several window-like openings in the housing wall and a support ring that can be placed onto the housing, said ring exhibiting a ring area at its face side, and legs and locking claws at its free ends. The support ring has the shape of a sliding collar consisting of a stop ring, located at an axial distance from it, an inner ring, webs connecting the stop ring and the inner ring as well as legs with locking claws at their free ends, extending from the inner ring to the stop ring. In a top view, these locking components exhibit a rectangular shape. Due to the structure of this connection element with a base body that is designed as a cylindrical housing, and a sliding collar that forms an inner sleeve, it can be considered a two-part object.

An additional connection and attachment component of the aforementioned kind is known from DE 197 14 661 A1. The coupling element for corrugated pipes shown in it comprises a housing into which the end of the corrugated hose can be pushed, and a ring with resiliently flexible tongues supported in a sliding manner at the housing. At their radial insides, the tongues feature protruding engagement catches for engaging in a circumferential groove of the corrugated pipe. The shape of the tongues is rectangular; the engagement catches of the tongues point towards the insertion opening. In this embodiment, the ring is supported at the outside of the housing, and its tongues extend through the opening of the housing to the corrugated pipe.

A similar attachment component is known from DE 195 40 280 C1, again in two parts, with a sleeve-shaped base body and a ring, which is, however, inserted on the inside into the base housing between the corrugated hose and the inside of the base housing. This adapter ring exhibits latches that engage in the troughs of the corrugations of the corrugated hose. To a certain extent, the latches are flexible and are provided with elevations radially towards the outside, said elevations being placed into breakthroughs, thus locking the adapter ring and with it, the corrugated hose in the base body.

Another connector for pipes made of synthetics is known from DE 690 04 194 T2. This connector is formed in one piece of a synthetic material and exhibits resilient hooks that are punched out in the base body. These latches bend resiliently outward, when a corrugated hose is pushed into the connector and engage then in a resilient manner into respective troughs of the corrugations of the corrugated hose.

Another one-piece connector with rectangular engagement fingers is known from DE 98 90 614 C2.

DE 39 03 353 A1 describes an attachment armature for pipes or hoses with circumferential fins, in particular for flexible corrugated hoses, with circumferential troughs or the like perpendicular to the hose axis, whereby the attachment armature features a sleeve that receives the end of the corrugated hose, and where in the wall of this sleeve is provided with a tongue that pivots against a restoring force of a spring area and extends in the axial direction with a protrusion that is directed towards the inside of the sleeve for engaging in a trough of the corrugation or the like of the corrugated hose or corrugated pipe for fixing it axially. This one-piece armature is characterized in that only one single tongue is provided. The tongue may exhibit different shapes; in one embodiment, it has a trapezoidal design, whereby the wide edge exhibits the engagement protrusion, and this engagement protrusion points away from the open end of the sleeve. In another embodiment, a narrow base section of an arm area is provided that expands in a trapezoidal manner towards the free end, which supports the engagement protrusion. In yet another embodiment, the tongue has a T-shaped design. In all embodiments, the end of the tongue, to which the engagement protrusion is attached, points away from the end of the attachment component.

WO 01/14780 A1 describes a connection and attachment component for a corrugated hose, which is designated as a securing coupling for corrugated pipes, is designed in one piece and exhibits resilient arms that exhibit a trapezoidal shape and for which the engagement protrusions are arranged at the wider end; the resilient arms are oriented such that their engagement ends point away from the insertion end of the corrugated hose.

Tests have shown that the various connection and attachment components as described above offer a very different hold for the corrugated hoses and/or corrugated pipes arranged at them, especially when the corrugated pipe is subjected to a flexing movement. Furthermore, if the corrugated hoses are made of a softer material, a secure hold is not ensured.

On the foundation of the prior art described above, the invention has the underlying objective of providing a high-strength connection and attachment component for a corrugated hose such that it can be manufactured easily and that a simple attachment to a corrugated hose is made possible, and in particular to ensure that a corrugated hose is held securely in the attachment component, even if the corrugated hose is subject to a strong movement, such as a flexing movement, for example, in addition to high tensile forces.

This objective is a achieved by a connection and attachment component with the aforementioned features, which is characterized in that at least two resilient arms are provided and are dimensioned such that their engagement protrusions extend across at least 50% of the inner circumference of the base body, in that the respective resilient arm—viewed in the circumferential direction of the base body, exhibits a width Be of its free end, which corresponds to at least 1.5 times the width Bb of its base end, and that the respective resilient arm exhibits a length Ln from the base end to the free end that is greater than the width Bb of its base end. By dimensioning the engagement protrusions such that together they extend across at least 50% of the inner circumference of the base body, and by the stated dimensioning of the respective resilient arm in relation to the circumferential direction of the base body, both good resilience and easy disassembly is achieved at an otherwise high holding force. Through the stated dimensioning of the length Ln of the respective resilient arm, which is greater than the width Bb of its base end, an optimum resilience of the resilient arm is achieved especially at occurring flexing movements, such that in spite of the flexing movements, the corrugated hose does not separate from the connection and attachment component.

A connection and attachment component with the claimed features has led to better results in comparison to connection and attachment components according to the prior art even at greater loads and stresses.

It is preferred to select the length Ln shorter than the width Be of the free end. This achieves a good holding force.

One preferred dimension for the axial distance Lh of the free end of each resilient arm from the corrugated hose connection end is at least 0.8 times the width Bb of the base end of the resilient arm. The leads to a good performance under the effect of external forces; secure holding of the corrugated hose is ensured.

To distribute the holding forces evenly across the circumference of the corrugated hose, at least three or even four resilient arms should be provided and should furthermore be distributed evenly across the circumference of the connection and attachment component and thus across the circumference of the corrugated hose.

The sum total of the engagement protrusions of the resilient arms should extend across at least 50%, preferably across at least 60%, of the inner circumference of the base body in order to achieve a good holding force even under loads such as flexing movements at the hose. The width Be of the free end of the resilient arms should be at least 1.5 times the width Bb of its base end.

For optimum spring characteristics of the resilient arm, the length Ln of the resilient arm from the base end to the free end should be at least 1.2 times greater than the width Bb of its base end (13) and the Be to Ln ratio should be at least 1.4.

To counteract even further the hose from flexing out of the corrugated hose connection end of the connection and attachment component, the axial distance Lh of the free end of each resilient arm from the corrugated hose connection end should be at least 2 times the distance Lf of the base end of the resilient arm from the connection element end.

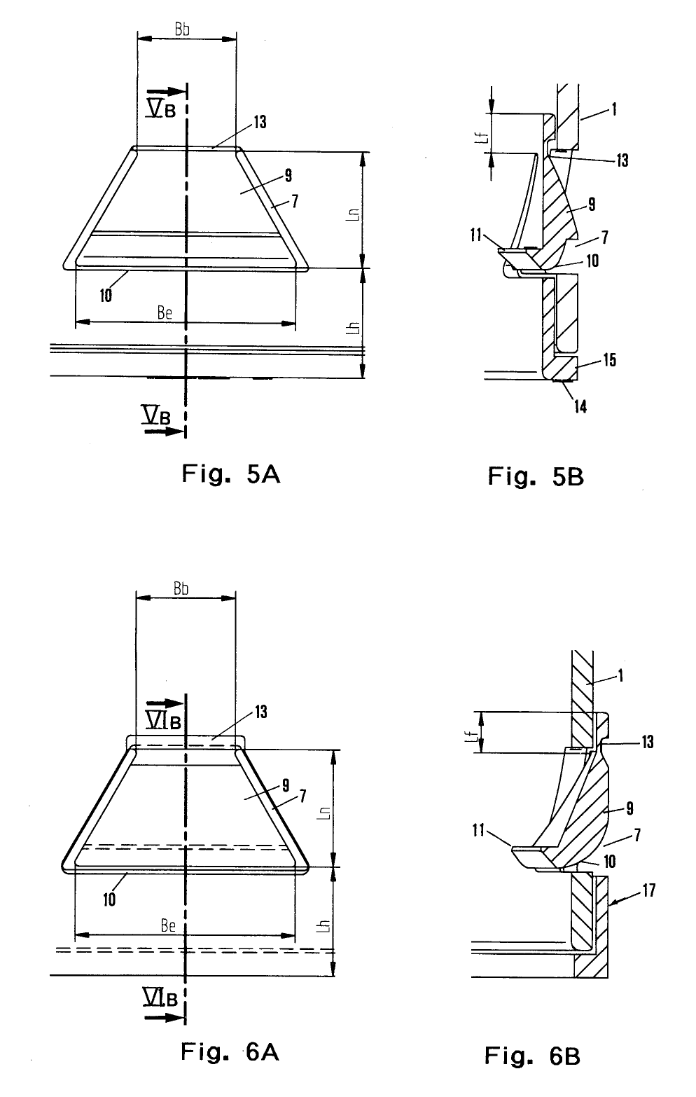

To the extent that the description above includes dimensions, particular reference is made to FIGS. 5A and 5B for a better understanding and easier correlation of these dimensions to components of the connection and attachment component.

Additional details and features of the invention become apparent from the following description of an exemplary embodiment based on the drawing. In the drawing,

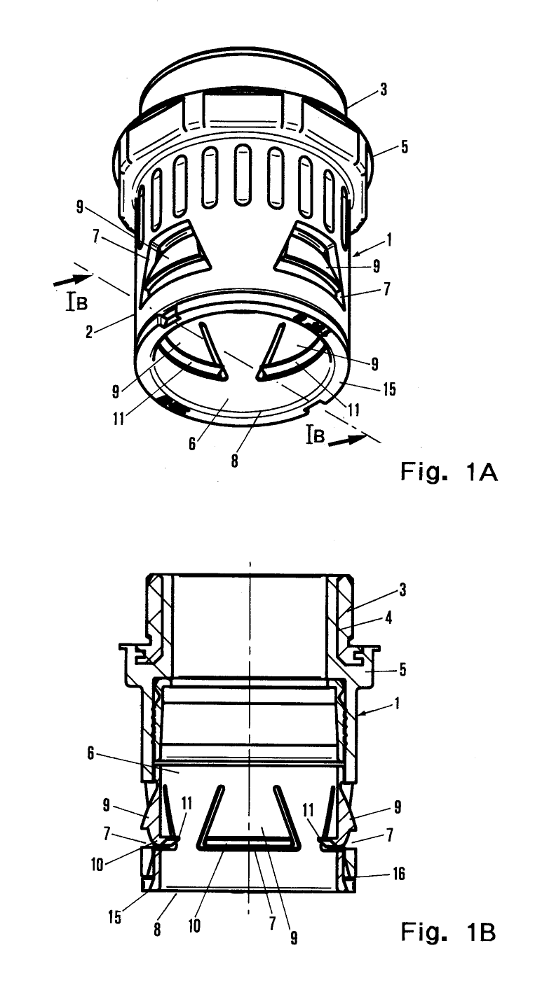

FIG. 1A shows a perspective view of a connection and attachment component with a sleeve-like base body and inserted in it an inner sleeve for a corrugated hose with a view onto the corrugated hose connection end.

FIG. 1B shows a sectional view of the connection and attachment component of FIG. 1A along the section line IB-IB.

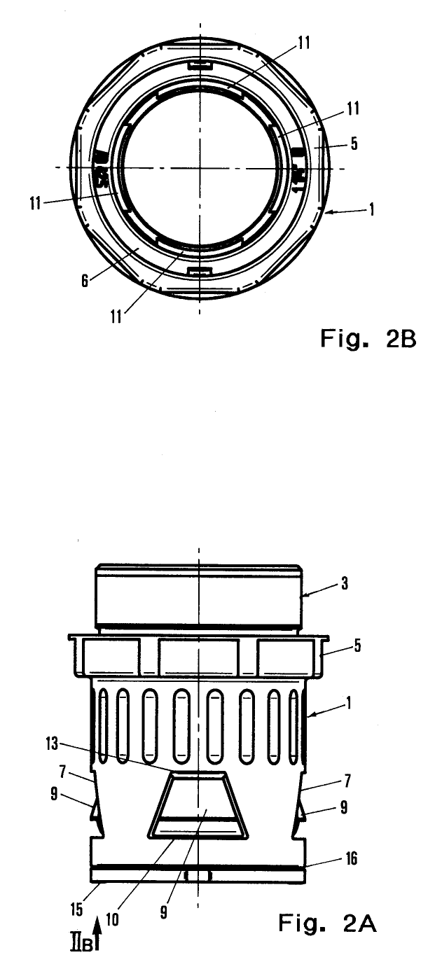

FIG. 2A shows a top view of the outer side of the connection and attachment component of FIGS. 1A and 1B.

FIG. 2B shows a view onto the corrugated hose connection end of the connection and attachment component of FIG. 2A from the view of the arrow IIB in FIG. 2A.

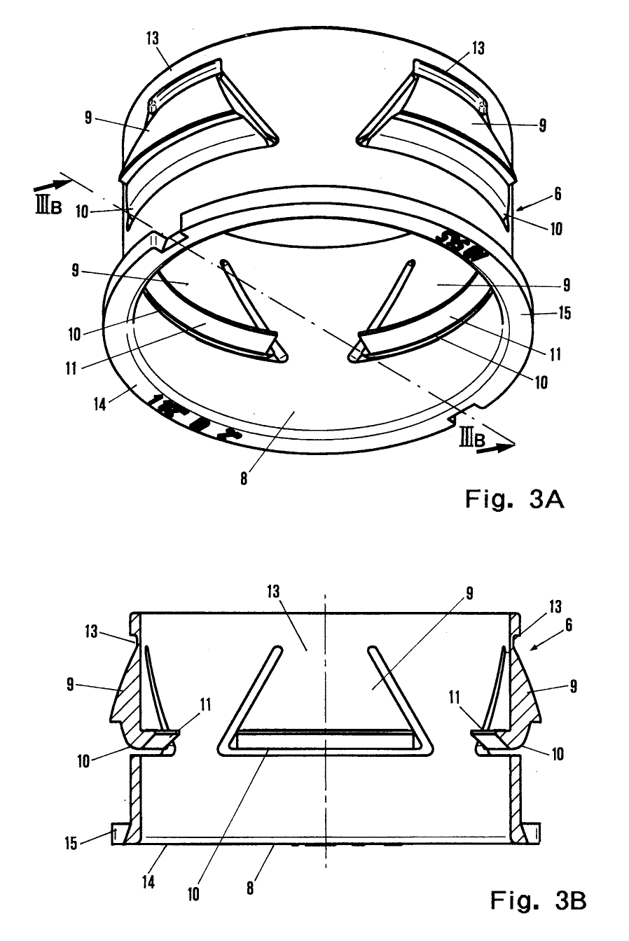

FIG. 3A shows a perspective view of only the inner sleeve, as it is inserted in the connection and attachment component and presented in FIG. 1A.

FIG. 3B shows a sectional view along the section line IIIB of FIG. 3A.

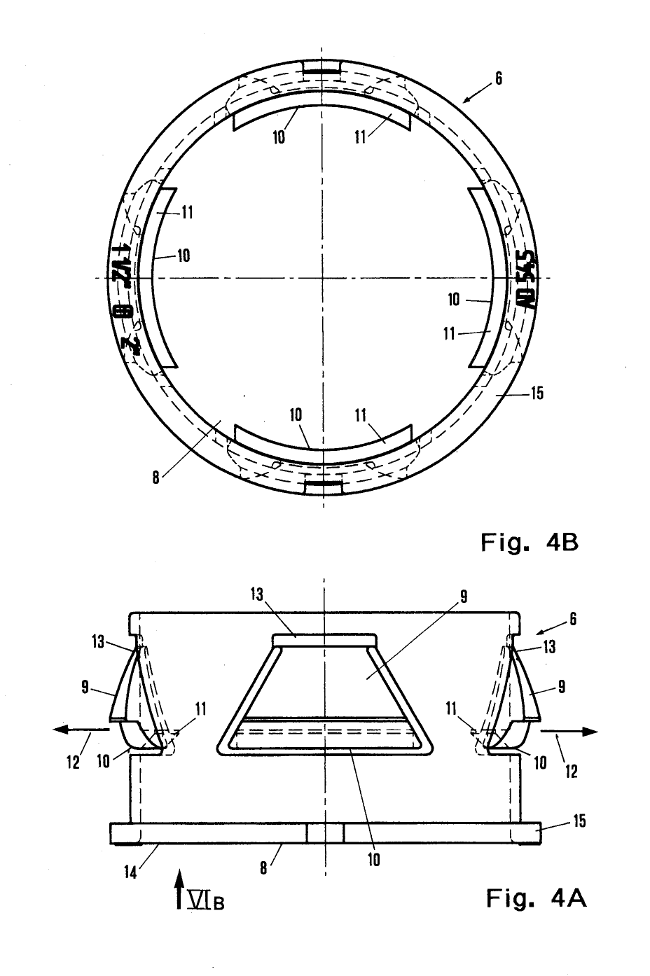

FIG. 4A shows an outer view of the inner sleeve of FIG. 3A.

FIG. 4B shows a top view of the end of the inner sleeve of FIG. 4A from the direction of the arrow IVB in FIG. 4A.

FIG. 5A shows a detail view of a resilient arm in order to illustrate the geometrical relations for an embodiment with an inner sleeve.

FIG. 5B shows a section along the section line VB-VB in FIG. 5A.

FIG. 6A shows a detail view of a resilient arm in order to illustrate the geometrical relations for an embodiment with an outer sleeve.

FIG. 6B shows a section along the section line VIB-VIB in FIG. 6A.

The connection and attachment component as shown in the Figures and in particular with initial reference to FIGS. 1 and 2 comprises a base body 1. The cylindrical base body 1 exhibits a corrugated hose connection end 2 and an opposite end that is designed as a connection element 3. The connection element 3 is provided with a thread that can be used to screw the connection and attachment component into an appropriate female thread, for example a pipeline. A circumferential flange 5, which can be designed as a wrench width (wrench engagement component) as a perforated crown or as a notched crown, is provided as a screw aid.

An inner sleeve 6 with a design that is recognizable more clearly in FIGS. 3 and 4 is inserted into the corrugated hose connection end 2.

Four breakthroughs 7, exhibiting a trapezoidal contour, are designed around the circumference of the base body 1 in the area where the inner sleeve 6 is inserted. The orientation of these breakthroughs 7 in the base body 1 is such that the wider area of the trapezoidal contour, that is, the footprint of this trapeze, points to the open end 8, from which a corrugated hose (not shown in the figures) is inserted into the connection and attachment component.

The inner sleeve 6 exhibits four resilient arms 9 distributed evenly around its circumference; in their position, the arms 9 correspond to the four breakthroughs 7 in the base body 1.

The resilient arms 9 also have a trapezoidal contour, corresponding to the breakthroughs 7, however, with slightly smaller outer dimensions than the breakthroughs 7, such that the resilient arms 9 can move freely outwards into the breakthroughs 7, when a pressure is applied to their insides.

Located at the free ends 10 of the resilient arms 9 are engagement protrusions 11 extending in a radial direction, said protrusions bending radially outwards, i.e., in the direction of the arrows 12 in FIG. 4A, when a corrugated hose is inserted via the open end 8 into the corrugated hose connection end 2 due to the flexing movements of the corrugated hose.

As becomes apparent from the Figures, the width Be is significantly greater than the base end 13 on the opposite side due to the trapezoidal shape of the resilient arms 9. A dimensioning rule is that the width Be of the resilient arm at its free end 10 is at least 1.5 times the width Bb of the base end 13 (see FIG. 5A). In the exemplary embodiment shown in the figures, the width Be corresponds to about 1.9 times the width Bb.

The length of the four engagement protrusions 11 is about two thirds of the inner circumference of the inner sleeve 6 as is apparent from FIG. 4B, which in turn means that the corrugated hose inserted in the inner sleeve 6 is held by the engagement protrusions 11 across about two thirds of its circumference.

The preferred length Ln of the resilient arms 9, i.e., the length in the axial direction of the connection and attachment component from the base end 13 to the free end 10, is selected such that it is greater than the width Bb of the base end 13; this improves the spring characteristics. On the other hand, the length Ln should not be greater than the width Be of the free end 10 of the resilient arm 9. The axial distance Lh of the free end 10 of the resilient arm 9 from the open end 8 of the inner sleeve 6 or the base body 1, respectively, should correspond to at least 0.8 times the width Bb of the base end 13. In this regard, the end 8 of the inner sleeve 6 is defined by the outer area 14 of a flange 15; this flange 15 that protrudes outward beyond the outer circumference of the inner sleeve 6 serves as a contact area for the inner sleeve 6 at the face area 16 of the base body 1 into which the inner sleeve 6 is inserted.

In addition, as shown in FIG. 5B, the axial distance Lh of the free end of each resilient arm from the corrugated hose connection end is at least 2 times the distance Lf of the base end of the resilient arm from the connection element end.

Preferred dimensions of connection and attachment components as described above as examples for typical hose diameters of corrugated hoses with 34.5 mm, 42.5 mm and 54.5 mm (outer diameter) can be taken from the table below.

| | Hose | | | | | | | |
|---|---|---|---|---|---|---|---|---|
| | outer | Circumference | | | | | | Engagement |
| | diameter | hose | Bb | Ln | Lh | Be | Lf | area |
| | (mm) | (mm) | (mm) | (mm) | (mm) | (mm) | (mm) | (mm) |
| Example 1 | 54.5 | 171.3 | 12.5 | 15 | 13 | 28.6 | 5 | 110.16 |
| | | | | | | | | (64%) |
| Example 2 | 42.5 | 133.45 | 12.0 | 14.5 | 11 | 21.9 | 5 | 87.72 |
| | | | | | | | | (65.7%) |
| Example 3 | 34.5 | 108.33 | 9.66 | 14.5 | 10 | 20.30 | 4 | 80.8 |
| | | | | | | | | (74.5%) |

The abbreviations in the table stand for:
Bb: Width of the resilient arm 9 at its base end 13
Ln: Length of the resilient arm 9 from the base end 13 to the free end 10
Be: Width of the resilient arm 9 at its free end 10
Lf: Distance of the base end 13 of the resilient arm 9 from the end of the connection element 2

From the Table, it is apparent that the condition Be ≧1.5×Bb is fulfilled, because in example 1 Be, the width of the free end of the resilient arm 9, corresponds to 2.288 times, in example 2 to 1.825 times and example 3 to 2.10 time Bb, the base end of the resilient arm 9.

Furthermore, in all examples the length Ln of the respective resilient arm 9 is smaller than the width Be. Also the rules Ln×1.2≧1.4 Bb and Be: Ln≧1.4 are fulfilled, which means that the length Ln of the resilient arm 9 from the base end 13 to the free end 10 is 1.2 times greater that the width Bb of its base end 13 and 1.4 times smaller than the width Be of the free end 10.

The last column shows the respective sum of the lengths of the engagement area of the four engagement protrusions 11 of the four resilient arms 9 in millimeters; the information in parentheses shows the engagement portion of the engagement protrusions of the connection and attachment components in percent in relation to the corresponding hose diameter, as is apparent from the first column. The four engagement protrusions 11 thus extend across at least 60% of the inner circumference of the base body 1.

In addition, the condition Lh≧0.8×Bb is fulfilled in these examples 1 to 3, whereby Lh defines the axial distance of the free end 10 of the resilient arm 9 from the corrugated hose connection end 2.

While FIGS. 5A and 5B show an arrangement where the resilient arms are arranged at an inner sleeve, FIGS. 6A and 6B show detail views of a resilient arm that is related to an outer sleeve, whereby this outer sleeve is designated with the reference character 17. In principle, the function of the arrangement of FIGS. 6A and 6B can be compared to the function of the arrangements of FIGS. 5A and 5B, such that the respective information for the FIG. 5 can be transferred to the FIG. 6, which, in particular, applies also to dimensioning; for this reason, a repetitive description of these features is omitted.

What is claimed is:

1. A connection and attachment component for a corrugated hose, having a sleeve-like base body that exhibits a corrugated hose connection end, and having an associated inner and outer sleeve, whereby the end of a corrugated hose can be pushed into the inner sleeve, which is inserted into the base body, or is inserted into the base body in conjunction with an outer sleeve, and the other end of it is designed in the form of a connection element, and whereby at least two resilient arms are provided at the sleeve, with each such arm being secured at its base end to the sleeve and at its other, free end exhibiting at least one radially progressing engagement protrusion, which extends inward beyond the inner circumference of the sleeve and can be brought into engagement with the corrugations of the corrugated hose such that it arrests the hose, whereby the base end relative to the free end points away from the corrugated hose connection end, the improvement comprising at least two resilient arms which are dimensioned such that their engagement protrusions extend at least across 50% of the inner circumference of the base body, wherein each respective resilient arm, viewed in the circumferential direction of the base body exhibits a width Be of its free end, which corresponds to at least 1.5 times the width Bb of its base end, wherein the respective resilient arm exhibits a length Ln from the base end to the free end, which is greater than the width Bb of its base end.

2. A connection and attachment component as set forth in claim 1, wherein the length Ln is smaller than the width Be of the free end.

3. A connection and attachment component as set forth in claim 1, wherein the axial distance Lh of the free end of each resilient arm from the corrugated hose connection end is at least 0.8 times the width Bb of the base end of the resilient arm.

4. A connection and attachment component as set forth in claim 1, wherein at least three resilient arms are provided.

5. A connection and attachment component as set forth in claim 4, wherein four resilient arms are provided.

6. A connection and attachment component as set forth in claim 5, wherein the engagement protrusions of the resilient arms extend across at least 60% of the inner circumference of the base body.

7. A connection and attachment component as set forth in claim 1, wherein the width Be of the free end of the resilient arm is at least 1.5 times the width Bb of its base end.

8. A connection and attachment component as set forth in claim 1, wherein the length Ln of the resilient arm from the base end to the free end is at least 1.2 times greater than the width Bb of its base end and in that the ratio of Be to Ln is at least 1.4.

9. A connection and attachment component as set forth in claim 1, wherein the axial distance Lh of the free end of each resilient arm from the corrugated hose connection end is at least 2 times the distance Lf of the base end of the resilient arm from the connection element end.
